(19) United States
(12) Patent Application Publication
(10) Pub. No.: US 2011/0003680 A1
(43) Pub. Date: Jan. 6, 2011

(54) MATERIAL FOR TRIBOLOGICAL APPLICATIONS

(76) Inventors: Gert Lindemann, Lichtenstein (DE); Matthias Leonhardt, Stuttgart (DE)

Correspondence Address: KENYON & KENYON LLP, ONE BROADWAY, NEW YORK, NY, 10004, US

(21) Appl. No.: 12/308,495

(22) PCT Filed: Sep. 11, 2007
(86) PCT No.: PCT/EP2007/059512

§ 371 Date: Sep. 15, 2010

(30) Foreign Application Priority Data
Oct. 30, 2006 (DE) 102006051201.4

(51) Int. Cl. C04B 35/46

(52) U.S. Cl. 501/134

(57) ABSTRACT

A metal-ceramic composite material especially for tribological applications, having a preform made of a ceramic material and having copper or a copper alloy as metal component, the ceramic proportion being in the range between 30 and 80 vol. % inclusively and the proportion of copper or the copper alloy being in the range between 20 and 70 vol. % inclusively.

The present invention relates to a material for tribological applications according to the definition of the species in claim 1.

### BACKGROUND INFORMATION

Rising demands on tribological components, that is components stressed by friction, especially on brake disks or brake drums used in vehicles, require materials having a high resistance to corrosion and wear, a high heat conductivity and a high mechanical strength, as well as high temperature resistance up to temperatures of 900° C.

Materials normally used for such application purposes, such as gray cast iron, are no longer able to satisfy these requirements, especially with respect to corrosion resistance and wear resistance, many of them even now, but particularly for requirement profiles to be expected in the future.

One new material approach is composite materials based on corrosion-resistant metal phases and wear-reducing ceramic proportions, particularly so-called metal-ceramic composite materials (such as “metal-matrix composites”=MMC). One may distinguish, in this instance, on the one hand, “cast MMC” materials, in which 20 vol. % ceramic fibers or particles are admixed to the metal phase to be poured, and on the other hand, “preform MMC” materials, for the production of which porous ceramic blanks, so-called preforms are infiltrated using a metal melt while applying an external pressure.

In the last case, as a result, interpenetrating networks are created of ceramic phase and metal phase having implementable ceramic proportions of up to 80 vol. %. The high ceramic proportion causes preform-MMC materials to be more corrosion and wear resistant than cast-MMc materials.

Since as early as 1997, brake disks and brake drums have been manufactured using cast-MMC materials based on aluminum. For example, the rear axle brake drums of the VW small car model Lupo 3L have been made of a material having the brand name Duralcan. This material is composed of 80 vol. % of an aluminum casting alloy and 20 vol. % ceramic particles (SiC), and is produced by the so-called “stir casting method”, which is described in U.S. Pat. No. 4,865,806. The advantage, in this case, is the low density of the material achieved by the predominant use of an aluminum alloy (2.8 g/cm³, compared to brake disks made of the standard material, gray cast iron, which is 7.2 g/cm³). In this material formulation, the disadvantageous effect is the low ceramic proportion, which is characteristic for cast MMC's, and which severely limits the potential of raising the wear resistance.

In addition, it is true in general for aluminum-based cast and preform MMC materials that the low melting temperature and softening temperature of the relevant aluminum alloys of less than 600° C. excludes them from use as brake material for heavy and powerful vehicles, that is, in particular, medium and upper class vehicles, SUV's, vans and sports cars, since high braking temperatures may be expected in these instances. The reason is the high energy transfer to the frictional surface of the brake disk or drum during the braking process, which is able to lead to temperatures in excess of 700° C.

### DISCLOSURE OF THE INVENTION

It is therefore the object of the present invention to provide a material for tribological applications, particularly as brake disk or drum, which, in spite of its low weight, has a high temperature resistance and, in addition, ensures a clear improvement in wear resistance and corrosion resistance.

This object is attained by the features of claim 1. The dependent claims indicate preferred specific embodiments.

Accordingly, a metal-ceramic composite material is provided especially for tribological applications, having a preform made of a ceramic material, and having as metal component copper or a copper alloy, the ceramic proportion being in a range between 30 and 80 vol. % inclusively, and the proportion of the copper or copper alloy being in the range between 20 and 70 vol. %, inclusively.

The clearly greater achievable ceramic proportion because of the preform method, in comparison to cast MMC's, of up to 80 vol. %, acts advantageously on the wear resistance and the corrosion resistance of the materials. This leads to a longer service life, greater optical brilliance and improved braking comfort.

By using a preform MMC having a high melting metal phase, namely copper or a copper alloy, a clearly higher application temperature is made possible in addition, compared to aluminum-based materials. The materials according to the present invention are therefore able to be used as brake materials for a significantly broadened vehicle segment.

When it comes to the copper alloy, it is provided especially advantageously that Cu-ETP, CuMgₓ, CuAlₓ, CuSiₓ, CuZrₓ, CuTiₓ, CuZnₓ or CuAlₓFe_{y}Ni_{z}, is involved.

The proportion of the copper or a copper alloy of the metal-ceramic composite material especially preferably amounts to 25-60 vol. %.

As the ceramic material for the preform, oxides (e.g. TiO₂, Al₂O₃), carbides (e.g. SiC, TiC, WC, B₄C), nitrides (e.g. Si₃N₄, BN, AlN, ZrN, TiN), borides (e.g. TiB₂) and/or silicates come into consideration. In the production of the preform, the ceramic material is preferably present in the form of particles or fibers.

The ceramic materials may likewise also be used as reinforcing or functional elements (e.g. SiC or AlN for the improvement of the heat conductivity, ceramic fibers for the improvement of fracture toughness and strength, etc.).

Based on the fact that the preform has a porous ceramic basic structure, into which the copper melt or the molten alloy is infiltrated, there comes about an intimate composition between the preform and the solidifying metal. Interpenetrating networks of metal and ceramics form in the process, the strength and toughness of the member being further increased.

The ceramic proportion of the metal-ceramic composite material particularly preferably amounts to 40-75 vol. %, in this instance.

Furthermore, a component for tribological applications, especially in vehicle construction, is provided having a metal-ceramic composite material according to one of the preceding claims

As components, especially brake disks or drums come into consideration, but other components do too, which have to bear high mechanical and thermal loads, at the same time are supposed to have a low specific weight, and in addition have to be corrosion resistant, especially in the construction of automobiles, motorcycles, aircraft and ships.

In order to avoid high thermal gradients or high thermal stresses, which may occur as a result of the high energy input during the frictional stress, the components preferably have a heat conductivity ( )>W/mK. This is brought about especially by the copper proportion, since copper has a very high specific heat conductivity.

The strength of the components amounts to >200 MPa, preferably >350 MPa. In this connection, the higher ceramic proportion compared to cast MCC's has an effect.

So as to make the use in heavy and powerful motor vehicles possible, one strives for a maximum temperature of use of >800° C. This is also achieved by the proportion of copper, since copper and copper alloys have higher melting points than aluminum or aluminum alloys.

Furthermore, a method is provided for producing a metal-ceramic composite material according to one of the preceding claims having the following steps:

a) Producing a porous ceramic blank (preform) by sintering, preferably of a ceramic material according to the above description (sintering step); and

b) infiltrating the preform with a melt of copper or a copper alloy, the preform having previously been brought to a temperature close to the melting temperature of the copper or the copper alloy (infiltration step).

The porosity of the preform amounts to 20-70 vol. %, preferably 25-60 vol. %, in this instance. By porosity one should understand the ratio of the volume of all hollow spaces in a porous solid to its outer volume, the hollow spaces, in this connection, being generally connected to one another in a network-like manner, and have an exchange or are connected with the atmosphere surrounding the porous solid (so-called open porosity). In other words, a measure is involved for the space that the actual solid matter takes up within a specific volume or which cavities it leaves behind in it. The pores are generally filled with air. As a rule, the volume proportions of the ceramic component and the metal component of a preform MMC, that are later to be expected, are therefore specified by the porosity of a preform.

In order to avoid thermal shocks and premature solidification of the metal melt in the front of the infiltration, it must also be managed that the ceramic blank has a temperature close to the melting temperature, the temperature difference being not greater than 350° C., preferably not greater than 100° C.

This may be managed by using a melt infiltration using squeeze casting by preheating the blank outside the casting tool, the blank being inserted into the casting tool immediately before the infiltration process.

To avoid thermal shock and premature cooling of the blank, the casting tool should preferably be preheated, and direct contact between casting tool and blank should be avoided, for instance, by a spacer or by lining with an insulating material such as ceramic paper or ceramic nonwoven fabric.

One additional measure may be to surround the preheated ceramic blank with an insulating covering, such as ceramic paper or ceramic nonwoven fabric or a hollow steel member adapted to the shape. The infiltration using metal melt takes place in a reaction-supported or a nonreactive manner, that is, only a reaction limited to the surface zone of the ceramic phase takes place or no reaction takes place between the metal phase and the ceramic phase. Because of a surface reaction of the ceramic phase, the infiltration quality may be improved and the infiltration pressure may be lowered (the cause for this being the heat of reaction that is liberated or the changed surface tension based on the newly formed interface phase).

Furthermore, it is provided that one or more pore-forming materials should be added to the ceramic material before sintering. As a rule, these are elongated materials that are easily burned off, which combust during sintering and thereby produce a network of channels and pores, which facilitates the subsequent infiltration of the molten metal and allows an intimate connection between the preform and the hardening metal. The channels produced in this manner may have a width of 2-50 μm, preferably 5-30 μm. The metal channels filling the channels in the finished body increase the strength and toughness of the bodies.

The pore-forming materials—together with the set sintering parametes—have an important influence on the setting of a specific porosity. However, pore-forming materials may also be used in the production of ceramic preforms, in particular, in order to produce a network of pore channels, which result in better infiltrability of the blank; the pore channels function as infiltration channels in this case. In addition, the metal channels created in this manner increase the strength and toughness of the material.

Especially preferred, in this instance, are cellulose platelets or fibers having a volume proportion of 1-30%, preferably 2-20%. In addition, soot particles, rice starch or organic macro molecules such as fullerenes or nanotubes are conceivable as pore-forming materials. Any materials that burn off, disintegrate or gas out during sintering and produce cavities in the material in this manner are essentially suitable as pore-forming material.

Furthermore, materials that release gas during sintering and cause the forming of pores in this manner are conceivable as well. In this context, NaHCO₃ is an option, which releases CO₂ when heated.

Furthermore, it is provided that the melt of copper or a copper alloy is infiltrated while an outer pressure is applied

As possible methods, particularly gas pressure infiltration or melting infiltration using the known technique of “squeeze casting” come into consideration.

### EXAMPLES

A ceramic blank made of TiO₂, that had a porosity of 50 vol. %, was infiltrated in a squeeze cast method, using a melt of Cu-ETP. The mechanical strength of the Cu-MMC material obtained was determined to be 384 MPa, and the heat conductivity was 91 W/mK. The corrosion rate of this Cu-MMC in water at 35° C. is lower by a factor of 28 than for gray cast iron, and the wear rate is lower by two orders of magnitude than that of gray cast iron.

1-7. (canceled)

8. A metal-ceramic composite material for tribological applications, comprising:
a preform made of a ceramic material; and
copper or a copper alloy as a metal component, a ceramic proportion being in a range between 30 and 80 vol. % inclusively, and a proportion of copper or the copper alloy being in a range between 20 and 70 vol. % inclusively.

9. The metal-ceramic composite material as recited in claim 8, wherein the metal amount is the copper alloy, the copper alloy being an alloy selected from the group including Cu-ETP, CuMgₓ, CuAlₓ, CuSiₓ, CuZrₓ, CuTiₓ, CuZnₓ, and CuAlₓFe_{y}Ni_{z}.

10. The metal-ceramic composite material as recited in claim 8, wherein the ceramic material for the preform is one or more of the materials selected from the group consisting of oxides, carbides, nitrides, borides and silicates.

11. A component for a tribological application in a vehicle construction, the component formed of a metal-ceramic material, comprising:
a preform made of a ceramic material; and
copper or a copper alloy as a metal component, a ceramic proportion being in a range between 30 and 80 vol. % inclusively, and a proportion of copper or the copper alloy being in a range between 20 and 70 vol. % inclusively.

12. A method for producing a metal-ceramic composite material, comprising:
producing a porous ceramic blank by sintering; and
infiltrating the preform with a melt of copper or a copper alloy, the preform having previously been brought to a temperature close to a melting temperature of the copper or the copper alloy;
wherein a ceramic proportion is in a range between 30 and 80 vol. % inclusively, and a proportion of copper or the copper alloy being in a range between 20 and 70 vol. % inclusively.

13. The method as recited in claim 12, wherein one or more pore-forming materials are added to the ceramic material before sintering.

14. The method as recited in claim 12, wherein the melt of copper or copper alloy is infiltrated while an outer pressure is applied.
